(19) United States
(12) Patent Application Publication
(10) Pub. No.: US 2005/0225090 A1
(43) Pub. Date: Oct. 13, 2005

(54) Island network and method for operation of an island network

(76) Inventor: Aloys Wobben, Aurich (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/380,786

(22) PCT Filed: Sep. 5, 2001
(86) PCT No.: PCT/EP01/10191

§ 371 Date: Apr. 18, 2005

(30) Foreign Application Priority Data
Sep. 7, 2000 (DE) 100 44 096.7

(51) Int. Cl. F03D 9/00; H02P 9/04

(52) U.S. Cl. 290/44

(57) ABSTRACT

The invention relates to an island network with at least one energy generator, using regenerative energy sources, whereby the energy generator is preferably a wind energy plant with a first synchronous generator, a DC link, at least one first power rectifier and a power inverter, a second synchronous generator and an internal combustion engine which may be coupled with the second synchronous generator. A fully controllable wind energy unit (10) and an electromagnetic coupling (34) between the second synchronous generator (32) and the internal combustion engine (30) are provided in order to establish an island network in which the internal combustion engine can be switched off completely, so long as the wind energy unit is generating enough power for all connected users with an efficiency which is as high as possible.

### BACKGROUND OF THE INVENTION

1. Field of the Invention

The present invention pertains to an isolated electrical network with at least one energy producer that is coupled to a first generator. A second generator, which may be coupled to an internal combustion engine, is also provided. In such an isolated network, the energy producer connected to the first generator is frequently a regenerative energy producer such as a wind energy system, a hydroelectric power plant, etc.

2. Description of the Related Art

Such isolated networks are generally known and serve particularly to provide power to areas that are not connected to a central power supply network but in which regenerative energy sources such as wind and/or solar and/or water power are available. These areas may be islands or remote and/or inaccessible areas with peculiarities with regard to size, location and/or climatic conditions. Even in such areas, however, a supply of electricity, water and heat is necessary. The energy required for this, at least the electrical energy, is provided and distributed by the isolated network. Modern electrically operated equipment also requires compliance with relatively narrow limit values for voltage and frequency fluctuations in the isolated network for proper functioning.

Among other ways to comply with these limit values, wind/diesel systems are used, in which a wind energy system is used as the primary energy source. The alternating current produced by the wind energy system is rectified and subsequently converted via an inverter into alternating current at the required network frequency. In this way, a network frequency is generated that is independent of the rotational speed of the generator in the wind energy system and thus of the frequency of the latter.

The network frequency is thus determined by the inverter. Two different variants are available in this regard. The first variant is a so-called self-commutated inverter, which is capable itself of generating a stable network frequency. Such self-commutated inverters, however, require a high degree of technical effort and are correspondingly expensive. An alternative to self-commutated inverters are line-commutated inverters, which synchronize the frequency of their output voltage: to an existing network. Such inverters are considerably more economical than self-commutated inverters, but always require a network to which they can synchronize themselves. Therefore, a pulse-former that supplies the control parameters necessary for line commutation must always be provided for a line-commutated inverter. For known isolated networks, such a pulse-former is, for instance, a synchronous generator that is driven by an internal combustion engine, such as a diesel engine.

That implies that the internal combustion engine must run continuously to drive the synchronous generator as a pulse-former. This too is disadvantageous for reasons of maintenance requirements, fuel consumption and pollution of the environment with exhaust because, even if the internal combustion engine need provide only a fraction of its available power for driving the generator as a pulse-former—the power often amounts to only 3-5 kW—the fuel consumption is not inconsiderable and amounts to several liters of fuel per hour.

An additional problem for known isolated networks consists in the fact that reactive loads referred to as “dump loads,” which consume the excess energy produced by the primary energy producer, must be present so that, when loads are disconnected, the primary energy producer does not go into idle operation, which could in turn lead to mechanical damage in the primary energy producer due to an excessive rotational speed. This is very problematic particularly for wind energy systems as the primary energy producer.

### SUMMARY OF THE INVENTION

The invention is based on avoiding the aforementioned disadvantages to solve the problem of the prior art and improving the efficiency of an isolated network.

The problem is solved according to the invention with an isolated electrical network according to claims 1 and 16 and a method of controlling the operation of an isolated network according to claim 18. Advantageous refinements are described in the subordinate claims.

The invention is based on the recognition that the second generator, which has the function of a pulse-former, can also be driven by the electrical energy of the first generator, which is usually the primary energy producer, such as a wind energy system, so that the internal combustion engine can be shut off completely and decoupled from the second generator. In this case the second generator is not in generator mode but rather in motor mode, the required electrical energy being supplied by the primary electrical energy producer or the first generator. If the clutch between the second generator and the internal combustion engine is an electromagnetic clutch, then this clutch can be actuated by the application of electrical energy from the primary energy producer or its generator. If the electrical energy is shut off at the clutch, the clutch is disengaged. When the internal combustion engine is not operating, electrical energy is then applied to the second generator, as described above, and it is driven in motor mode so that the pulse-former remains in operation, despite the shut-down internal combustion engine. Whenever it is necessary to start the engine and go into generator mode, the internal combustion engine can be started and coupled to the second generator by means of the electrically operated clutch so that, in generator mode, this second generator can provide additional energy for the isolated electrical network.

The use of a fully controllable wind energy system makes it possible to do without “dump loads,” since the wind energy system is capable by virtue of its complete controllability, i.e., its variable speed and variable blade adjustment, of producing precisely the required amount of power so that “disposal” is not necessary, since the wind energy system produces precisely the required power. Because the wind power system produces only as much energy as is needed in the network or for further charging of interim storage, no excess energy need be eliminated uselessly and the overall efficiency of the wind energy system, but also that of the isolated network, is considerably better than when “dump loads” are used.

In a preferred embodiment of the invention, the wind energy system contains a synchronous generator with a downstream dc-ac converter. This dc-ac converter consists of a rectifier, a dc link and a variable-frequency inverter. If another source providing a dc voltage or direct current such as a photovoltaic element is installed in the network, then it is expedient for such additional primary energy producers such as photovoltaic elements to be connected to the dc link of the dc-ac converter, so that the energy of the additional regenerative energy source can be fed into the dc link. In that way, the energy supply available from the first primary energy producer can be increased.

In order to compensate for fluctuations in the available power and/or an increased power demand spontaneously as well as to make use of available energy that is non-instantaneously in demand, it is preferable to provide interim storage units that can store electrical energy and release it quickly when needed. Such storage units can be electrochemical storage devices such as rechargeable batteries, but also capacitors (caps) or chemical storage units such as hydrogen accumulators, in which hydrogen produced by electrolysis from the excess electrical energy is stored. In order to release their electrical energy, such storage units are also connected, directly or via appropriate charge/discharge circuitry, to the dc link of the dc-ac converter.

An additional form of energy storage that may be used is conversion into energy of rotation, which is stored in a flywheel. This flywheel is connected in a preferred refinement of the invention to the second synchronous generator and thus likewise makes it possible to utilize the stored energy to drive the pulse-former.

Electrical energy can be supplied to all storage units whenever the consumption of energy in the isolated network is less than the power capacity of the primary energy producer, for instance, the wind energy system. If, for example, the primary energy producer is a wind energy system with 1.5 MW nominal power or a 10 MW nominal power wind park with several wind energy systems and wind conditions are such that the primary energy producer can be run at nominal operation, but the power consumption in the isolated network is clearly less than the nominal power of the primary energy producers, it is possible in such an operation (especially at night and during times of low consumption in the isolated network) for the primary energy producer to be run such that all energy storage units are charged (filled), so that in those times when the power consumption of the isolated network is greater than power supply of the primary energy producer the energy storage units can be turned on first, sometimes only for a short time.

In a preferred refinement of the invention all energy producers and interim storage units except the energy component, for example, the internal combustion engine, or flywheel, connected to the second generator can be connected to a shared dc link configured like a bus and terminated by a single line-commutated inverter (dc-ac converter). By using a single line-commutated dc-ac converter on a dc link, a very economical arrangement is created.

It is also advantageous if additional or redundant internal combustion engines and third generators (e.g., synchronous generators) are provided so that, in case of a greater demand for power than is available from the regenerative energy producers and stored energy, it can be produced by operating the additional or redundant production systems.

### BRIEF DESCRIPTION OF THE DRAWINGS

Embodiments of the invention are described in greater detail below for the sake of example. Shown are:

FIG. 1, a schematic circuit diagram of an isolated network according to the invention;

FIG. 2, a variant of the schematic shown in FIG. 1 and

FIG. 3, a preferred embodiment of an isolated network according to the invention.

### DETAILED DESCRIPTION OF THE PREFERRED EMBODIMENTS

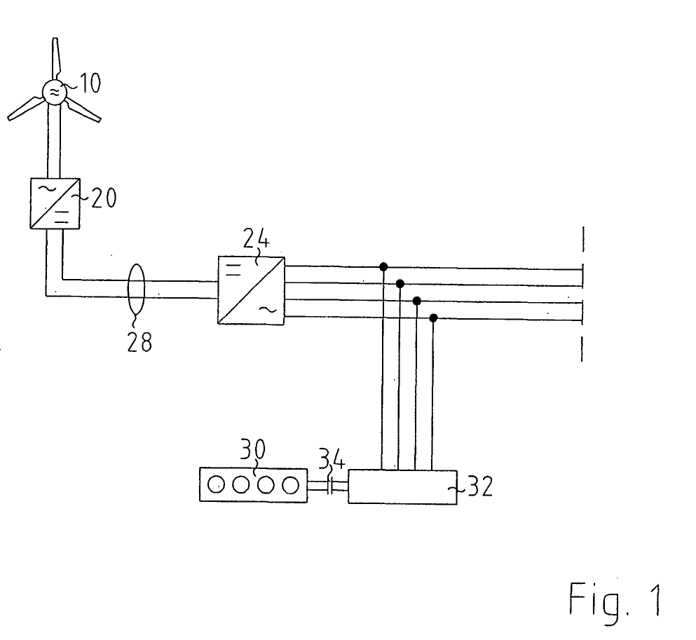

FIG. 1 shows a wind energy system 10 having a first generator therein with a downstream inverter consisting of a rectifier 20, via which the wind energy system is connected to a dc link 28, as well as a dc-ac converter 24 connected to the output of dc link 28.

A second synchronous generator 32, connected in turn via an electromagnetic clutch 34 to an internal combustion engine 30, is connected in parallel to the output of dc-ac converter 24. The output lines of dc-ac converter 24 and second synchronous generator 32 supply the loads (not shown) with the required energy.

Wind energy system 10 produces the power for supplying the loads. The energy produced by wind energy system 10 is rectified by rectifier 20 and fed into dc link 28.

The dc-ac converter 24 produces alternating current from the direct current applied to it and feeds it into the isolated network. Since dc-ac converter 24 is designed as a line-commutated dc-ac converter 24 for reasons of cost, a pulse-former is present, to which the dc-ac converter can synchronize itself.

This pulse-former is the second synchronous generator 32. This synchronous generator 32 operates in motor mode with internal combustion engine 30 turned off and acts as a pulse-former. In this mode the driving energy is the electrical energy from the wind energy system 10. This energy for driving synchronous generator 32, just like the losses of rectifier 20 and dc-ac converter 24, must be additionally produced by wind energy system 10.

In addition to its function as a pulse-former, second synchronous generator 32 fulfills other tasks such as producing reactive energy in the network, supplying short-circuit current, acting as a flicker filter and regulating voltage.

If loads are switched off and the energy requirements therefore decrease, then wind energy system 10 is controlled in a known manner such that it produces correspondingly less energy, so that the use of dump loads can be dispensed with.

If the energy demands of the loads increase to the point that they can no longer be covered by the wind energy system alone, internal combustion engine 28 can start up and voltage is applied to electromagnetic clutch 34. Clutch 34 thereby creates a mechanical connection between internal combustion engine 30 and second synchronous generator 32. The generator 32 is now in generator mode, and it continues to operate as a pulse-former, and it also supplies the additional required energy.

By appropriate dimensioning of wind energy system 10 it is possible on average for enough energy to supply the loads to be provided from wind energy. The usage of internal combustion engine 30 and the associated fuel consumption can thereby be reduced to a minimum.

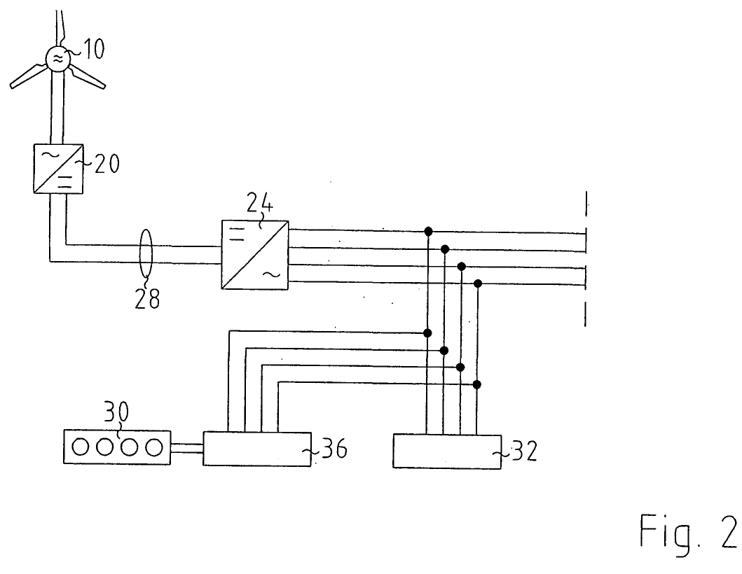

FIG. 2 shows a variant of the isolated network shown in FIG. 1. The structure essentially corresponds to the solution shown in FIG. 1. The difference is that here no internal combustion engine 30 is associated with second generator 32, which acts as a pulse-former. Internal combustion engine 30 is instead connected to an additional, third (synchronous) generator 36 which can be turned on as needed. Second synchronous generator 32 thus constantly operates in motor mode as pulse-former, reactive power producer, short-circuit current source, flicker filter and voltage regulator.

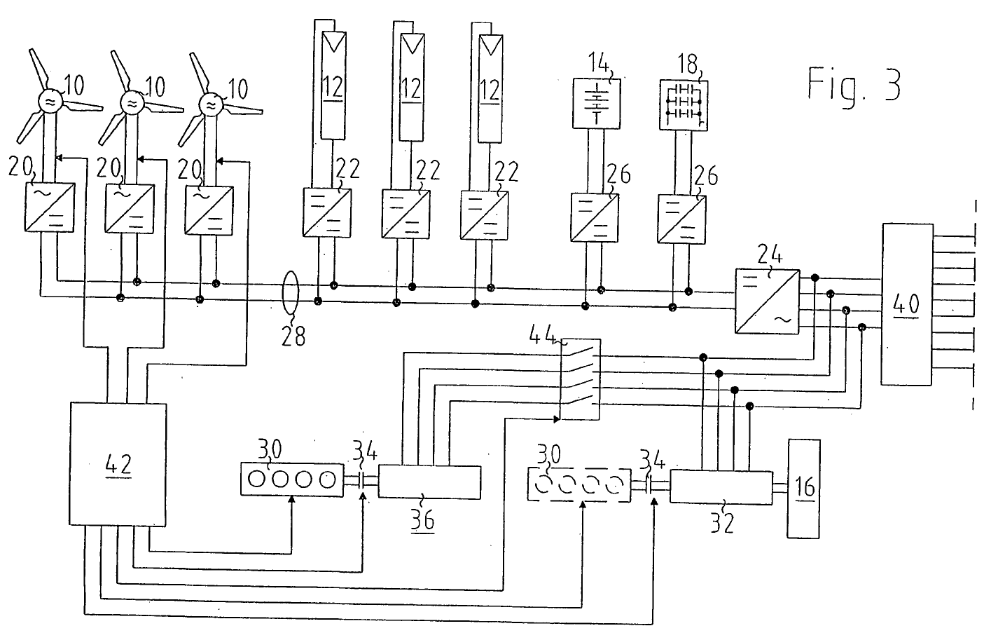

FIG. 3 shows an additional preferred embodiment of an isolated network. In this figure, three wind energy systems 10, forming a wind park as an example, are shown with (synchronous) generators, each connected to a rectifier 20. The rectifiers 20 are connected in parallel on the output side and feed the energy produced by wind energy systems 10 into a dc link 28.

Also shown are three photovoltaic elements 12, each connected to a step-up converter 22. The output sides of the step-up converters 22 are likewise connected in parallel to dc link 28.

Also shown is a storage battery block 14 which symbolically stands for an interim storage unit. In addition to being an electrochemical storage unit such as storage battery 14, this interim storage unit can also be a chemical one such as a hydrogen accumulator (not shown). The hydrogen accumulator can be filled, for instance, with hydrogen obtained by electrolysis.

Illustrated next to it is a capacitor block 18 which shows the possibility of using appropriate capacitors as interim storage. These capacitors could, for instance, be so-called Ultra-Caps made by the Siemens company, which are distinguished by low losses as well as high storage capacity.

Accumulator block 14 and capacitor block 18 (each block can also be formed from more than one unit) are connected via charge/discharge circuits 26 to dc link 28. The dc link 28 is terminated by a single dc-ac converter 24 (or a plurality of dc-ac converters in parallel), dc-ac converter 24 preferably being constructed to be line-commutated.

A distributor 40 (possibly with a transformer) that is supplied with the line voltage by dc-ac converter 24 is connected to the output side of dc-ac converter 24. Likewise connected to the output side of dc-ac converter 24 is a second synchronous generator 32. This synchronous generator 32 is the pulse-former, reactive power and short-circuit current producer, flicker filter and voltage regulator of the isolated network.

A flywheel 16 is coupled to second synchronous generator 32. This flywheel 16 is likewise an interim storage unit and can store energy, for instance, during motor-mode operation of the pulse-former.

An internal combustion engine 30 and an electromagnetic clutch 34, which drive generator 32 in generator mode in case of insufficient power from regenerative sources, can likewise be associated with second synchronous generator 32. In this way, needed energy can be fed into the isolated network.

Internal combustion engine 30 associated with second synchronous generator 32 and electromagnetic clutch 34 are shown in dashed lines to clarify that second synchronous generator (if desired, with a flywheel as interim storage unit) can alternatively be operated only in motor mode as pulse-former; reactive power and short-circuit current producer, flicker filter and voltage regulator.

Particularly if second synchronous generator 32 is provided without internal combustion engine 30, a third synchronous generator 36 can be provided with an internal combustion engine to compensate for a lengthier power deficit. In the idle state, this third synchronous generator 36 can be separated by a switching unit 44 from the isolated network so as not to burden the isolated network as an additional load.

Finally, a microprocessor or computer controller 42 is provided, which controls the individual components of the isolated network and thus allows a largely automated operation of the isolated network.

By appropriate design of the individual components of the isolated network, it is possible for wind energy systems 10 on average to produce sufficient energy for the loads. This supply of energy is augmented by the photovoltaic elements, if needed.

If the supply of power available from wind energy systems 10 and/or photovoltaic elements 12 is smaller/larger than the needs of the loads, interim storage units 14, 16, 18 can be called upon (discharged/charged), either to provide the missing power (discharging) or to store the surplus power (charging). Interim storage units 14, 16, 18 thus smooth out the always-fluctuating supply of regenerative energy.

What power fluctuation can be compensated for what span of time is largely a function of the storage capacity of interim storage units 14, 16, 18. For a generous dimensioning of the interim storage units, time spans of a few hours to a few days are possible.

Starting up internal combustion engines 30 and second or third synchronous generators 32, 36 is necessary only for power deficits that exceed the capacity of interim storage units 14, 16, 18.

In the above description of embodiments, the primary energy producer was always one that uses a regenerative energy source, such as wind or solar (light). The primary energy producer can also make use of another regenerative energy source, for instance, hydropower, or be a producer that consumes fossil fuels.

It is also possible for a seawater desalination plant (not shown) to be connected to the isolated network so that in times when the loads on the isolated network require considerably less energy than the primary energy producers can provide, the seawater desalination plant will consume the “surplus” electric power, i.e., the additional amount that could be provided, to produce usable water/drinking water, which can then be stored in catch basins. Should the energy consumption of the isolated network be so great that all energy producers are just barely able to provide this power, then the seawater desalination plant will be reduced to a minimal operation, or possibly turned off entirely. The control of the seawater desalination plant can also be accomplished via controller 42.

In times when only part of the electric power from the primary energy producers is required by the isolated network, it is also possible to operate a pump storage plant, also not shown, by means of which water (or other fluid media) is brought from a lower to a higher potential, so that the electric power from the pump storage plant can be used if needed. Control of the pump storage plant can also be accomplished via controller 42.

It is also possible for the seawater desalination plant and a pump storage plant to be combined by pumping the usable water (drinking water) produced by the seawater desalination plant to a higher potential, which can then be used to drive the generators of the pump storage plant.

Of course, various combinations of the components of the systems shown in FIGS. 1-3 can also be constructed and these fall within the scope of the present invention. From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An isolated electrical network with at least one first energy producer that uses a regenerative energy source, wherein the energy producer is preferably a wind energy system with a generator, wherein a second generator that can be coupled to an internal combustion engine is provided, characterized in that
a) the wind energy system is controllable in regard to its rotational speed and blade adjustment;
b) the wind energy system can be controlled such that it always produces only the required electric power, the required power being composed of the consumption of electric power in the network and the power needed to charge an interim electricity storage unit; and
c) when the power produced by the wind energy system falls below power R, network power is initially not provided by the internal combustion engine, but instead interim electricity storage units are called upon to release energy to the network.

2. The isolated electrical network according to claim 1, characterized in that the first energy producer has a synchronous generator which contains an inverter with a dc link with at least one rectifier and a dc-ac converter.

3. The isolated electrical network according to claim 1, characterized by at least one electrical element connected to the dc link for feeding in dc electrical energy.

4. The isolated electrical network according to claim 3, characterized in that the electrical element is a photovoltaic element and/or a mechanical energy accumulator and/or an electrochemical storage unit and/or a capacitor and/or a chemical storage unit as electrical interim storage unit.

5. The isolated electrical network according to claim 1, characterized by a flywheel that can be coupled to the second or a third generator.

6. The isolated electrical network according to claim 1, characterized by several internal combustion engines, each of which can be coupled to a generator.

7. The isolated electrical network according to claim 1, characterized by a controller for controlling the isolated network.

8. The isolated electrical network according to claim 1, characterized by a step-up or step-down converter between the electrical element and the dc link.

9. The isolated electrical network according to claim 1, characterized by charge/discharge circuits between the electrical element and the dc link.

10. The isolated electrical network according to claim 1, characterized by a flywheel with a generator and a downstream rectifier for feeding electrical energy into dc links.

11. The isolated electrical network according to claim 1, characterized in that all energy producers using regenerative energy sources and interim storage units feed a shared dc link.

12. The isolated electrical network according to claim 1, characterized by a line-commuted dc-ac converter.

13. The isolated electrical network according to claim 1, characterized in that the energy for operating the electromagnetic clutch is provided by an electricity storage unit and/or by the primary energy producer.

14. The isolated electrical network according to claim 1, characterized in that a seawater desalination/usable water production plant is connected to the isolated network and produces usable water whenever the power supply from the primary energy producer is greater than the power consumption of the other electric loads connected to the isolated network.

15. The isolated electrical network according to claim 1, characterized in that a pump storage plant which receives its electrical energy from the primary energy producer is provided.

16. An isolated electrical network comprising:
at least one first primary energy producer for producing electrical energy for an isolated electrical network;
a synchronous generator that has the function of a pulse-former, wherein the synchronous generator can operate in motor mode and the energy required operation in motor mode is provided by the primary energy producer.

17. The isolated electrical network according to claim 16, characterized in that the generator can be connected via a clutch to an internal combustion engine that is turned off whenever the electric power from the primary energy producer is greater than or roughly as large as the consumed electric power in the isolated network.

18. The method according to claim 1, characterized in that internal combustion engines are provided to drive at least one second generator and the internal combustion engines are switched on only if the energy emitted by energy producers using regenerative energy sources and/or by interim electricity storage units falls below a specificiable threshold value for a specificiable time span.

19. The method according to claim 18, characterized in that more energy than is required for the loads connected to the network is produced from regenerative sources in order to charge the interim storage units.

20. An electrical supply network comprising:
a synchronous generator as a pulse-former for a line-commutated dc-ac converter for feeding an alternating current into the electricity supply network, wherein the generator operates in motor mode and the driving of the generator to operate in motor mode is accomplished by a flywheel or by providing electrical energy from a regenerative energy producer.
